(19) United States
(12) Patent Application Publication
(10) Pub. No.: US 2005/0151844 A1
(43) Pub. Date: Jul. 14, 2005

(54) Portable baby monitoring system for vehicles

(76) Inventors: Mamie W. Chiao, San Francisco, CA (US); Richard Chiao, San Francisco, CA (US)

Correspondence Address: GLENN PATENT GROUP, 3475 EDISON WAY, SUITE L, MENLO PARK, CA, 94025, US

(21) Appl. No.: 10/756,059

(22) Filed: Jan. 12, 2004

(51) Int. Cl. H04N 7/18

(52) U.S. Cl. 348/148; 348/143

(57) ABSTRACT

The invention comprises of a baby monitoring system that uses an automotive type monitor and a closed circuit camera, preferably a camera having low light capability. The monitor is situated in an area within the driver's line of vision, such as on a console, the dashboard, the rearview mirror, etc. The camera is mounted in an area outside the driver's line of vision, such as the rear seat or trunk or any area that is outside of the driver's view. This arrangement enables the driver to monitor the child, for example, a child who is secured in a rearward-facing child seat, as well as provides the monitor of a disabled person, animals, precious cargo, or other situations where a driver's immediate attention may be required or where constant monitoring may be required, but where it is preferred that the driver not divert his attention away from the operation of the vehicle.

### BACKGROUND OF INVENTION

1. Technical Field

The invention relates to the monitoring of a baby in a vehicle. More particularly, the invention relates to an apparatus that monitors a baby who is secured in a rearward-facing seat while riding in a vehicle.

2. Description of the Prior Art

Parents constantly want to monitor their child to ensure the child's well-being. This is true in all cases, most particularly, while the child is secured in a rearward-facing seat while in a vehicle. Further, a number of people have accidentally left their child in the car because they have forgotten about the child while driving the automobile. Unfortunately, drivers are often distracted by the tasks of driving and other interruptions such as cell phones, traffic conditions, and other daily distractions.

Various arrangements have been proposed to assist a driver in viewing various areas of a vehicle while operating the vehicle. For example, the HitchCAM™ provides a rearview mirror-mounted monitor and a trailer hitch-mounted camera to allow one to see behind an automobile. The VideoMirror™ with BabyVue™ provides a mirror or windshield-mounted monitor and ceiling-mounted camera that allow an individual to monitor a baby while the individual is operating a vehicle. U.S. Pat. No. 6,485,154, Car Seat Safety Mirror, provides a mirror that is attached to a car safety seat by means of a flexible stem connected to a base module attached to the car seat. The flexible stem of the mirror allows the mirror to be positioned so that the baby may be viewed. Unfortunately, all such devices have limitations that render them short in practicality.

It would be advantageous to provide a removable viewing system for automotive applications that allows the driver to view the areas outside of the driver's line of vision while driving or when the vehicle is stationary, in particular to monitor a child fastened in a rearward-facing baby seat, without diverting one's eyes from the road while operating the vehicle.

### SUMMARY OF THE INVENTION

The invention comprises of a baby monitoring system that uses an automotive type monitor and a closed circuit camera, preferably a camera having low light capability. The monitor is situated in an area within the driver's line of vision, such as on the console, the dashboard, the rearview mirror, etc. The camera is mounted in an area outside the driver's line of vision, such as the rear seat or trunk, or any area that is outside of the driver's view. This arrangement enables the driver to monitor the child, for example, a child who is secured in a rearward-facing child seat, as well as provides the monitor of a disabled person, animals, precious cargo, or other situations where a driver's immediate attention may be required or where constant monitoring may be required, but where it is preferred that the driver not divert his attention away from the operation of the vehicle.

### BRIEF DESCRIPTION OF THE DRAWINGS

FIG. 1 is a block schematic diagram of a baby monitoring system according to the invention; and

FIG. 2 is a schematic perspective view of a baby monitoring system in accordance with the invention.

### DETAILED DESCRIPTION OF THE INVENTION

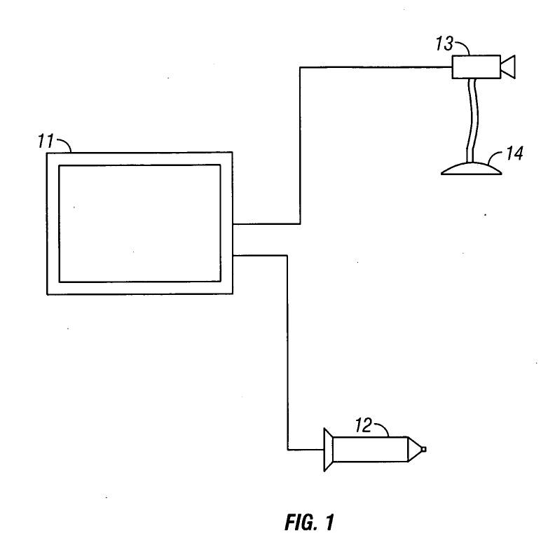

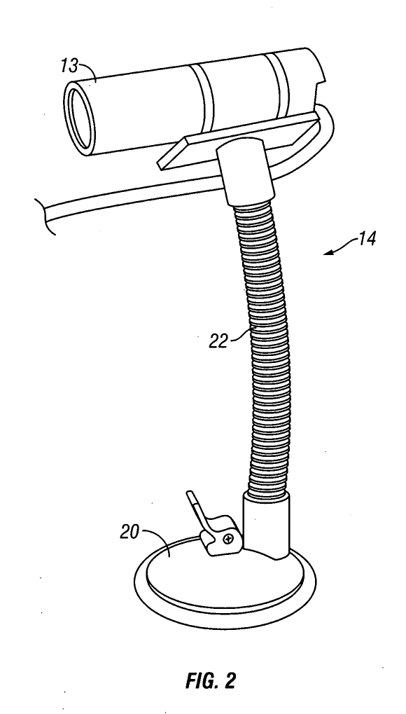

The invention provides an automotive type monitor and a closed circuit camera within a vehicle that allows the vehicle operator to monitor activities that are not within the driver's field of view. The presently preferred embodiment provides a monitor and camera as shown in FIGS. 1 and 2. The monitor (11) and camera (13) may be powered by the vehicle's internal power source. For example, they may be connected to the vehicle's 12-volt DC power supply, such as a cigarette lighter connector (12) or other connector.

A key feature of the invention is that the camera is attached on a suction cup and gooseneck base (14). Various gooseneck arrangements for cameras are known. See for example U.S. Pat. No. 6,244,759, Adjustable Camera Support, as well as such products as Video Labs, Flexcam. The use of a combination gooseneck having a flexible portion (22) (See FIG. 2) and a suction cup (20) allows the camera to be mounted conveniently within the vehicle by attaching the suction cup to an interior portion of a vehicle window. In the presently preferred embodiment, a baby camera is situated towards a rearward-facing infant seated in a baby seat. The camera and suction cup are readily attached to the rear window of the vehicle and the camera is positioned by flexing the gooseneck to allow the camera to capture the baby's face and body. Unlike prior art, for example as exemplified in the VideoMirror™ with BabyVieW™ discussed above, the camera is not permanently mounted to the vehicle and thus may be removed and placed in any convenient location for any monitoring application. Thus, the camera provides a retrofitable installation. As such, the baby monitor may be moved from vehicle to vehicle so that the child may be monitored in any of a number of vehicles within the family or on vacation, for example where a rental car is being used.

The automotive type monitoring screen may be an LCD or other type screen that provides a black and white or color display of the monitored subject, although any monitor may be applied in the application envisioned by the invention. While not as critical as the mounting of the camera, the mounting of the monitor may be accomplished by use of a suction cup and/or gooseneck as well. This allows the same flexibility of the mounting of the camera. They have the same advantages as discussed above.

The camera is preferably a low-light security camera that is powered by the car's power supply. The low-light capability camera allows the driver to see the subject, for example the baby in a low-light application, such as in a tunnel, at night, in an underground parking lot, or other areas that may be poorly lit, etc. The connection between the camera and the monitor may be either a wired connection or a wireless connection as desired. Further, the camera may be adapted to operate with a built-in monitor, such as the monitors provided in built-in navigation or entertainment systems. The communication of information from the monitor in such devices is known to those skilled in the art.

Once the baby monitoring system is installed in the car, the driver is able to view the monitor conveniently without diverting his eyes from the road and yet view what the camera is viewing. Thus, the video monitor is preferably installed within the driver's view or, alternatively, within a front seat passenger's view, if a passenger is monitoring the child. The camera is mounted into any area desired for viewing and in an area not readily available to the driver while driving without diverting his attention away from the task of driving. As discussed above, the preferred embodiment of the camera provides a suction cup and gooseneck arrangement, although other temporary arrangements are also contemplated by the invention. A key feature of the invention is that the placement of the monitoring system is removable, making it both temporary and arbitrary at the desire of the vehicle operator.

Although the invention described herein with reference to the preferred embodiment, one skilled in the art will readily appreciate that other applications may be substituted from those set forth herein without departing from the spirit and scope of the present invention. Accordingly, the invention would only be limited by the Claims included below.

1. A baby monitor comprising:
a camera positioned to view a baby who is secured in a rearward-facing seat within a vehicle;
a camera mount comprising a suction cup and gooseneck, said camera mount providing temporary and adjustable fixation of said camera within said vehicle; and
a display for receiving signals from said camera, wherein said display is positioned within the line of sight of a vehicle operator.

2. The baby monitor of claim 1, said camera comprising either of a black and white or a color camera.

3. The baby monitor of claim 1, said camera comprising a low light security camera.

4. The baby monitor of claim 1, said display further comprising a display mount comprising a suction cup and gooseneck.

5. The baby monitor of claim 1, wherein said camera is secured to a vehicle rear window by said camera mount.
